(19) United States
(12) Patent Application Publication
(10) Pub. No.: US 2022/0414825 A1
(43) Pub. Date: Dec. 29, 2022

(54) IMAGE STITCHING METHOD

(71) Applicant: V5 TECHNOLOGIES CO., LTD., Hsinchu City (TW)

(72) Inventors: Sheng-Chih HSU, Hsinchu City (TW); Chien-Ting CHEN, Hsinchu City (TW)

(73) Assignee: V5 TECHNOLOGIES CO., LTD., Hsinchu City (TW)

(21) Appl. No.: 17/305,042

(22) Filed: Jun. 29, 2021

(51) Int. Cl. G06T 3/40; G06T 7/33; G06T 3/60

(52) U.S. Cl. CPC G06T 3/4038; G06T 7/337; G06T 3/60; G06T 2207/20212

(57) ABSTRACT

An image stitching method is proposed to include: A) acquiring a plurality of segment images for a target scene, each of the segment images containing a part of a target scene; B) for two adjacent segment images, which are two of the segment images that have overlapping fields of view, comparing the two adjacent segment images to determine a stitching position for the two adjacent segment images from a common part of the overlapping fields of view; and C) stitching the two adjacent images together based on the stitching position thus determined.

### FIELD

The disclosure relates to an image stitching method, and more particularly to a real-time image stitching method.

### BACKGROUND

In some photography conditions where a camera does not have a sufficient field of view to capture an image that fully includes a target scene because of magnification limitations, multiple images each containing a part of the target scene may be captured and then stitched together to obtain a full image that includes a complete view of the target scene.

Some conventional image stitching methods use techniques such as feature extraction and feature mapping to determine a stitching section for the captured images. However, such techniques have great computation load requirements and are time-consuming, and are not suitable for a target scene that has a plurality of duplicated features, such as a circuit that has multiple semiconductor components that look the same, as they might be regarded as one and the same feature, as opposed to different features.

### SUMMARY

Therefore, an object of the disclosure is to provide an image stitching method that can alleviate at least one of the drawbacks of the prior art.

According to the disclosure, the image stitching method includes steps of: A) acquiring a plurality of segment images for a target scene, each of the segment images containing a part of a target scene; B) for two adjacent segment images, which are two of the segment images that have overlapping fields of view, comparing the two adjacent segment images to determine a stitching position for the two adjacent segment images from a common part of the overlapping fields of view; and C) stitching the two adjacent images together based on the stitching position thus determined.

### BRIEF DESCRIPTION OF THE DRAWINGS

Other features and advantages of the disclosure will become apparent in the following detailed description of the embodiment(s) with reference to the accompanying drawings, of which:

FIG. 1 is a schematic diagram illustrating an exemplary camera system to implement embodiments of an image stitching method according to this disclosure;

FIG. 2 is a schematic diagram illustrating a first manner a camera device captures segment images of a target scene;

FIG. 3 is a flow chart illustrating steps of an embodiment for stitching two adjacent images;

FIG. 4 is a schematic diagram exemplarily illustrating acquisition of a convolution region and a convolution kernel from the two adjacent images;

FIG. 5 is a schematic diagram exemplarily illustrating stitching of the two adjacent images;

FIG. 6 is a flow chart illustrating steps of a first embodiment of the image stitching method according to this disclosure;

FIG. 7 is a schematic diagram illustrating generation of stitch images in the first embodiment;

FIG. 8 is a schematic diagram illustrating a second manner the camera device captures segment images of a target scene;

FIG. 9 is a schematic diagram illustrating an effect of rotating the segment images when the segment images are captured in the second manner;

FIG. 10 is a flow chart illustrating steps of a variation of the first embodiment;

FIG. 11 is a flow chart illustrating steps of a second embodiment of the image stitching method according to this disclosure;

FIG. 12 is a schematic diagram illustrating correction of relative stitching positions into absolute stitching positions; and

FIG. 13 is a flow chart illustrating steps of a variation of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

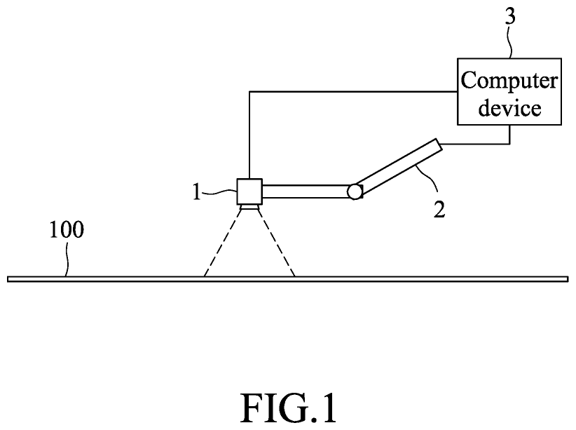

Referring to FIG. 1, an exemplary camera system to implement embodiments of an image stitching method according to this disclosure is shown to include a camera device 1, a moving mechanism 2 that is connected to the camera device 1 and that is operable to drive movement of the camera device 1, and a computer device 3 that is electrically connected to the camera device 1 and the moving mechanism 2 for controlling operation thereof. The movement of the camera device 1 may be one-dimensional, two-dimensional or three-dimensional, and the moving mechanism 2 may include, for example but not limited to, a robotic arm, a rotation shaft, other suitable mechanisms, or any combination thereof.

The moving mechanism 2 is controlled by the computer device 3 to move the camera device 1 to capture segment images of a target scene 100. In the illustrative embodiment, the target scene 100 is a planar scene such as a semiconductor circuit formed on a wafer. In other embodiments, the target scene 100 may be, for example, a wide view or a 360-degree panorama of a landscape, and this disclosure is not limited in this respect.

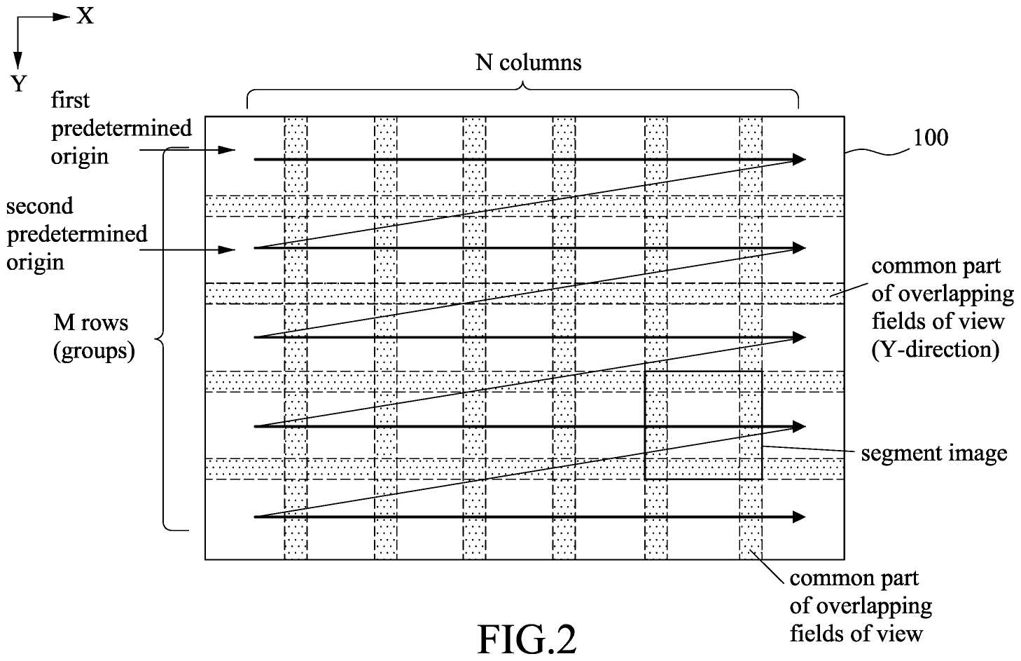

Reference is further made to FIG. 2, in a first embodiment of the image stitching method according to this disclosure, the camera device 1 starts from a first predetermined origin, moves in an X-direction from left to right, and uses continuous shooting to successively capture a first group (corresponding to the first row in FIG. 2) of the segment images while moving (i.e., when moving in the X-direction, the camera device 1 does not stop moving to capture one segment image and then move again, followed by stopping to capture another segment image, and so on). Then, the camera device 1 moves to a second predetermined origin that is aligned with the first predetermined origin in a Y-direction transverse to the X-direction), and moves in the X-direction from left to right to capture a second group (corresponding to the second row in FIG. 2) of the segment images using continuous shooting in the manner as described above. By repeating in such a manner, the first to M^{th} rows of the segment images are captured line by line (row by row) in sequence along the Y-direction (e.g., from top to bottom in this embodiment) for the target scene 100, and cooperatively form an M-by-N image array, where M and N are positive integers. The M-by-N image array includes the first to M^{th} groups (corresponding to first to M^{th} rows that are parallel to each other in FIG. 2) of the segment images, and each of the first to M^{th} groups includes N number of the segment images (referred to as first to N^{th} images hereinafter) that are captured one by one in sequence along the X-direction (e.g., from left to right in this embodiment). In other words, the segment images are classified into the first to M^{th} groups according to an order in which the segment images are captured. Each of the segment images contains a part of the target scene 100, and includes a plurality of pixels that cooperatively form an A-by-B pixel array, which is exemplified as a 1000-by-1000 pixel array in this embodiment for ease of explanation, where represents a number of rows of pixels, and “B” represents a number of columns of pixels. For each of the first to M^{th} groups, an n^{th} image and an (n+1)^{th} image have overlapping fields of view, and thus are adjacent segment images from the perspective of the target scene 100, where n is a variable that takes a positive integer value ranging from one to (N−1) (e.g., in the same group, a right portion of the first image and a left portion of the second image have the same field of view). An i^{th} image of an m^{th} group of the segment images and the i^{th} image of an (m+1)^{th} group of the segment images have overlapping fields of view, and thus are adjacent segment images from the perspective of the target scene 100, where m is a variable that takes a positive integer value ranging from one to (M−1), and i is a variable that takes a positive integer value ranging from one to N (e.g., a bottom portion of the first image of the first group and a top portion of the first image of the second group have the same field of view).

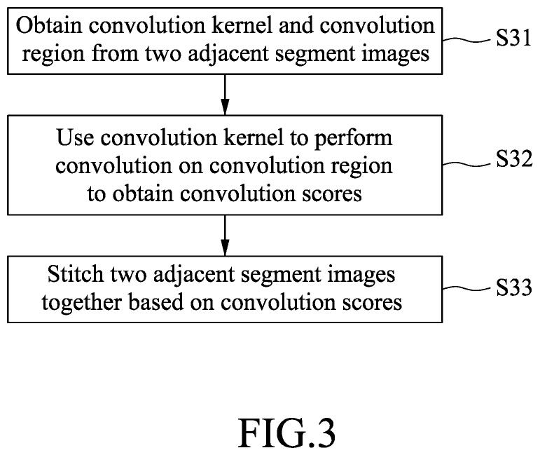

FIG. 3 illustrates a flow for stitching two adjacent segment images (e.g., the first and second images of the same group, the second and third images of the same group, the first images of the first and second groups, or the first images of the second and third groups, etc.) that have overlapping fields of view. In this disclosure, the embodiments of the image stitching method are exemplarily realized using convolution operation. In some embodiments, the disclosure may be realized using other suitable algorithms, for example, template matching, but is not limited in this respect.

In step S31, the computer device 3 obtains a convolution kernel from one of the two adjacent segment images, and defines a convolution region in the other one of the two adjacent segment images. The convolution kernel includes, at least in part, data of a common part of the overlapping fields of view, and the convolution region includes, at least in part, data of the common part of the overlapping fields of view. Usually, the convolution region is greater than the convolution kernel in size.

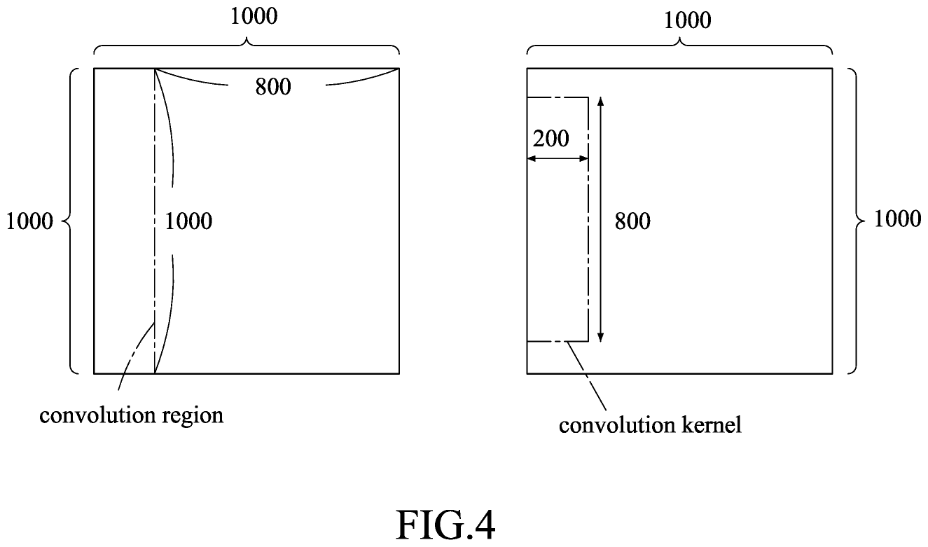

FIG. 4 exemplarily illustrates two 1000-by-1000 segment images that are adjacent in the X-direction (hereinafter referred to as a right segment image and a left segment image). Assuming that an 800-by-200 convolution kernel is obtained from the right segment image and a 1000-by-800 convolution region is defined in the left segment image, the convolution kernel may be a matrix that includes pixel data of an 800-by-200 block in the left portion (e.g., a 1000-by-200 block) of the right segment image, and the convolution region may be a matrix that includes pixel data of a 1000-by-800 block in the right portion of the left segment image because the common part of the overlapping fields of view should reside in the right portion of the left segment image and the left portion of the right segment image. It is noted that the convolution kernel and the convolution region are not required to be of a rectangular shape, and may be of a square shape or any suitable shape in other embodiments. Because the segment images in this embodiment are captured by the camera device 1 while moving in the X-direction, the right segment image and the left segment image may have a high overlapping ratio (could be nearly 100%) in the Y-direction. Accordingly, the convolution kernel can have a height that is close to a height of the right segment image, e.g., 80% of the height of the right segment image in this embodiment. However, the height of the convolution kernel is usually not taken to be 100% of the height of the segment image so as to reserve a tolerance for a condition where the moving direction of the camera device 1 is not perfectly parallel to the X-direction, which would make the right segment image and the left segment image not completely overlap in the Y-direction.

Referring to FIG. 3 again, in step S32, the computer device 3 uses the convolution kernel to perform convolution on the convolution region to obtain a plurality of convolution scores for different sections of the convolution region. For example, when the convolution is performed on the 800-by-800 convolution region, 800×800 number of convolution scores may be obtained respectively for 800×800 number of sections that respectively correspond the 800×800 number of pixels in the convolution region (e.g., a section may be a 200-by-200 part of the left segment image that is centered at the corresponding one of the pixels in the convolution region). Each convolution score can be seen as a similarity between the convolution kernel and the corresponding one of the sections of the convolution region. As a result, the section that corresponds to the highest convolution score may be determined as a stitching section of the segment image in which the convolution region is defined (e.g., the left segment image in FIG. 4).

Briefly, in steps S31 and S32, the computer device compares the two adjacent segment images to determine a stitching position (e.g., the stitching section) for the two adjacent segment images from the common part of the overlapping fields of view of the two adjacent segment images.

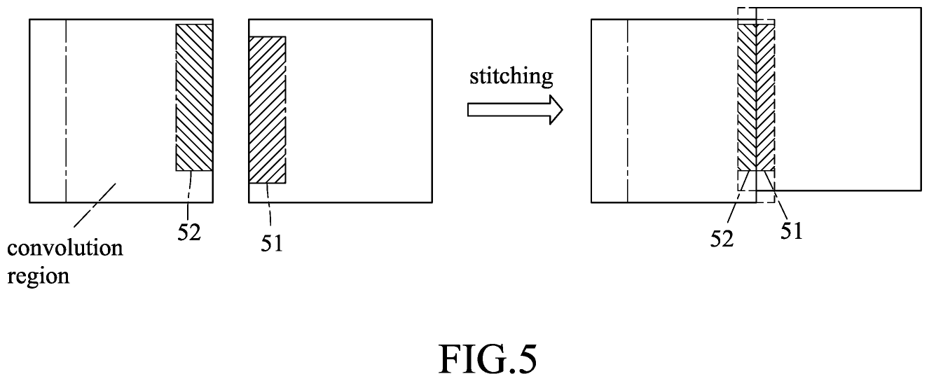

In step S33, the computer device 3 stitches the two adjacent segment images together based on the stitching position determined in step S32 by, for example but not limited to, aligning a section of the right segment image from which the convolution kernel is obtained with the stitching section that is determined based on the convolution scores. FIG. 5 exemplifies the stitching of the two adjacent segment images by aligning a section 51 in the right segment image from which the convolution kernel is obtained with the stitching section 52 that is determined based on the convolution scores. Because the moving direction of the camera device 1 may not be perfectly parallel to the X-direction of the target scene 100, the two adjacent segment images may have a shift in the Y-direction with each other when stitched together.

The flow introduced in FIG. 3 may serve as a basis for stitching the segment images of the M-by-N image array as shown in FIG. 2.

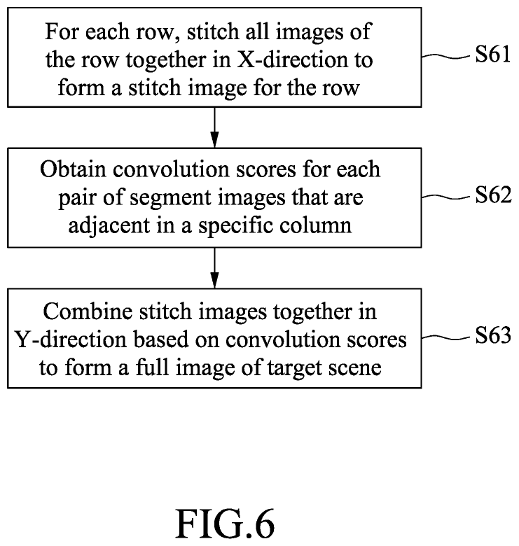

FIG. 6 illustrates a flow of the first embodiment of the image stitching method according to this disclosure.

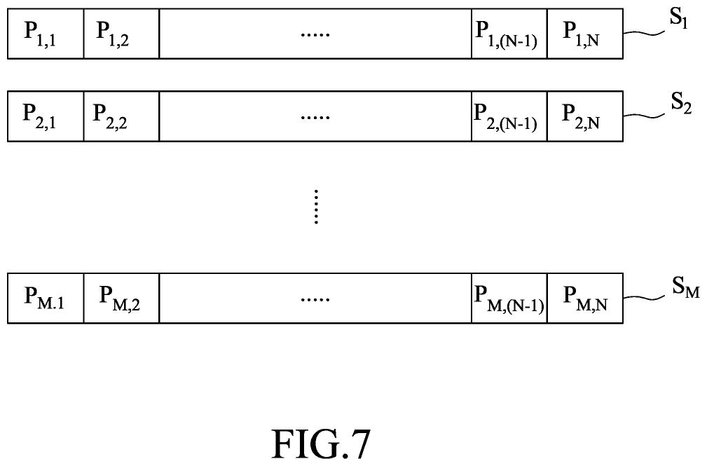

In the first embodiment, for each of the first to M^{th} groups (corresponding to the first to M^{th} rows in FIGS. 2 and 7), the camera device 1 uses continuous shooting to capture the first to N^{th} images (with an image being referred to as P_{j, i}, which represents an i^{th} image of a j^{th} group, where j is a variable that takes a positive integer value ranging from 1 to M) while moving in the X-direction. In step S61, for each value of j (i.e., for each group, or each row, from the perspective of the target scene 100) and for each value of n, once the n^{th} image P_{j, n} and the (n+1)^{th} image P_{j, n+1} of the j^{th} group (i.e., the two adjacent segment images in the same group) are captured, the computer device 3 performs steps S31 to S33 on the n^{th} image P_{j, n} and the (n+1)^{th} image P_{j, n+1} that serve as the two adjacent segment images in steps S31 to S33 (i.e., this operation is performed (N−1) times, each with the variable n being a corresponding integer (from 1 to N−1)), so as to stitch all the segment images of the group (the first to N^{th} images P_{j, 1}−P_{j, N} for the case depicted in FIG. 2) together in the X-direction to form a stitch image Sⱼ for the group (e.g., an image representing the j^{th} row in FIG. 7). It is noted that the term “once” is used herein to mean that, for any value of n, steps S31 to S33 are performed on the n^{th} image P_{j, n} and the (n+1)^{th} image P_{j, n+1} immediately after the n^{th} image P_{j, n} and the (n+1)^{th} image P_{j, n+1} are captured by the camera device 1, so as to reduce the total time required from starting to capture the segment images to completion of stitching all the segment images, and thus achieve real time processing. However, in some cases that do not require real time processing, steps S31 to S33 can be performed on each pair of adjacent segment images after the first to N^{th} images of the corresponding group are all captured, or after all of the segment images of the target scene 100 are captured, and this disclosure is not limited in this respect.

However, for each of the first to M^{th} groups, since the first to N^{th} images are captured using continuous shooting while the camera device 1 is moving, the common parts of the overlapping fields of view may vary in size for different pairs of adjacent segment images (e.g., the n^{th} image and the (n+1)^{th} image in the same row) because of mechanical errors and/or tolerances. Accordingly, multiple convolution kernels of different sizes and multiple convolution regions of different sizes may be obtained and defined herein for use in the following steps. The convolution kernels may be obtained to have a size that is equal to different predetermined kernel ratios of a size of the segment images. For example, assuming that the segment images have a resolution of 1000×1000 and the predetermined kernel ratios are 10%, 20% and 40% of a side length of the segment images, the convolution kernels could be 800×100, 800×200 and 800×400 in size (noting that the heights of the convolution kernels may be predetermined by users, and can be different for different convolution kernels in some embodiments). Similarly, the convolution regions may be defined to have a size that is equal to different predetermined region ratios of a size of the segment images. In the above examples, assuming that the predetermined region ratios for the convolution regions are 80%, 90% and 100% of the side length of the segment images, the convolution regions could be 1000×800, 1000×900 and 1000×1000 (i.e., the entire segment image) in size (noting that the heights of the convolution regions may be predetermined by users, and can be different for different convolution regions in some embodiments). Then, for each pair of adjacent segment images, convolution may be performed several times using different region-kernel combinations constituted by the convolution regions of different sizes and the convolution kernels of different sizes. In other words, steps S31 and S32 may be repeatedly performed on each pair of adjacent segment images (e.g., the n^{th} image and the (n+1)^{th} image of the same row), and, for each of the repetitions of steps S31 and S32, at least one of the convolution kernel or the convolution region is different in size from that of another repetition.

For each combination of the convolution region and the convolution kernel (i.e., for each region-kernel combination), multiple convolution scores may be obtained for multiple sections of the convolution region used in the combination. However, a larger convolution kernel may lead to higher convolution scores. Therefore, in step S61, the computer device 3 may normalize the convolution scores obtained in each of the repetitions of steps S31 and S32 based on the size of the convolution kernel used in the repetition, so as to eliminate the influence of the size of the convolution kernel. Then, the computer device 3 performs step S33 based on the convolution scores thus normalized for all of the repetitions of steps S31 and S32. In one implementation, the computer device 3 may make a section that corresponds to the highest normalized convolution score among the normalized convolution scores serve as the stitching section.

In step S62, a plurality of convolution scores are obtained for each pair of segment images that have the same ordinal number but are in two consecutive groups (simply, a pair of segment images that are adjacent in a specific column from the perspective of the target scene 100, such as the first images of the first and second rows in FIG. 2). Specifically, for the case depicted in FIG. 2, for a specific value of i (e.g., i=1) and for each value of m, the computer device 3 performs steps S31 and S32 on the i^{th} images of the m^{th} group and the (m+1)^{th} group of the segment images (i.e., two adjacent segment images in the same column in FIGS. 2 and 7) that serve as the two adjacent segment images, so as to obtain a plurality of convolution scores (which can be used to determine a stitching position) for the i^{th} images of the m^{th} group and the (m+1)^{th} group of the segment images. Referring to FIG. 7, for example, assuming i=1 and m=1, the computer device 3 performs steps S31 and S32 on the first images P_{1, l}, P_{2, 1} of the first and second groups to obtain a plurality of convolution scores for the first images P_{1, 1}, P_{2, 1} of the first and second groups. In such a case, the convolution kernel may be obtained from a top portion of the segment image P_{2, 1}, and the convolution region may be defined in the bottom portion of the segment image P_{1, 1}. It is noted that, since the position of the camera device 1 when capturing the first image of each of the first to M^{th} groups is predetermined in terms of, for example but not limited to, coordinates, the common parts of the overlapping fields of view for different pairs of adjacent first images in the Y-direction can be deemed as substantially the same in size, which is known, so the convolution kernel and the convolution region can each be of a single size that is predetermined.

In step S63, the stitch images of the groups are combined together in the Y-direction based on the convolution scores to form a full image of the target scene 100. Specifically, for the case depicted in FIG. 2, for the specific value of i and for each value of m, the computer device 3 stitches the stitch images of the m^{th} group and the (m+1)^{th} group together in the Y-direction based on the stitching position obtained for the i^{th} images of the m^{th} group and the (m+1)^{th} group of the segment images (i.e., this operation is performed (M−1) times, each with the variable m being a corresponding integer (from 1 to M−1)), so as to obtain a full image of the target scene 100. Referring to FIG. 7, for example, the computer device 3 may determine a section in the segment image P_{1, 1} that corresponds to the highest convolution score obtained in step S62 as a stitching section (stitching position) for the stitch image S₁ of the first row, and combine the stitch images S₁, S₂ of the first and second rows together by aligning a section in the segment image P_{2, 1} from which the convolution kernel is obtained in step S62 with the stitching section in the segment image P_{1, 1}. In such a manner, the stitch images S₁ to S_{M} can be stitched together to form the full image of the target scene 100.

It is noted that, in a case that requires real time processing, for any value of m, steps S62 and S63 may be performed once the stitch images of the m^{th} row and the (m+1)^{th} row (i.e., Sₘ, S₍ₘ₊₁₎) are obtained. In a case that does not require real time processing, steps S62 and S63 may be performed after all of the stitch images S₁ to S_{M} are obtained. In some cases, steps S61-S63 may be performed after all of the segment images are captured, and this disclosure is not limited in this respect.

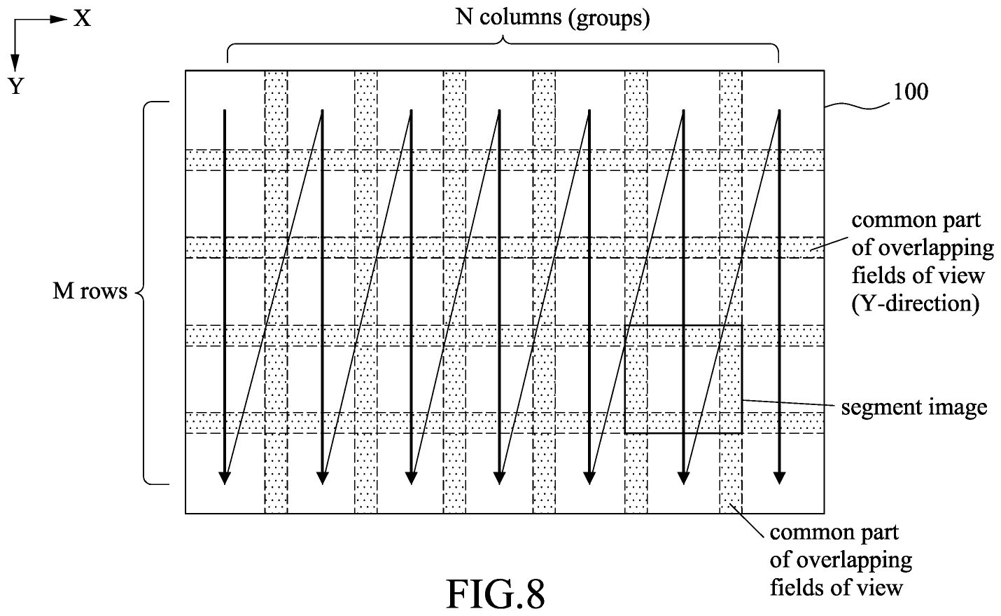

Referring to FIG. 8, in one implementation, the camera device 1 (see FIG. 1) may move in the Y-direction to capture the segment images column by column in sequence to obtain first to N^{th} groups (corresponding to first to N^{th} columns in FIG. 8) of the segment images, and, for each of the first to N^{th} groups, the camera device 1 uses continuous shooting to capture the segment images one by one in sequence to obtain first to M^{th} images of the group. In such a scenario, the flow introduced with reference to FIG. 6 can be altered by interchanging “row” and “column” and interchanging “X-direction” and “Y-direction”, as can be easily appreciated by one skilled in the art, so details thereof are omitted herein for the sake of brevity.

In practice, without altering the flow literally described in FIG. 6 (this unaltered flow of FIG. 6 will also be referred to as a “prescribed flow” hereinafter), which is designed to specifically perform stitching of the segment images in the “X-direction” row by row to generate the stitch images of the first to last rows first, followed by combining the stitch images in the “Y-direction” to obtain the full image of the target scene 100, when this (prescribed) flow is expected to be applied to perform stitching on segment images that are captured in the manner as shown in FIG. 8, some preprocessing on the segment images may be needed.

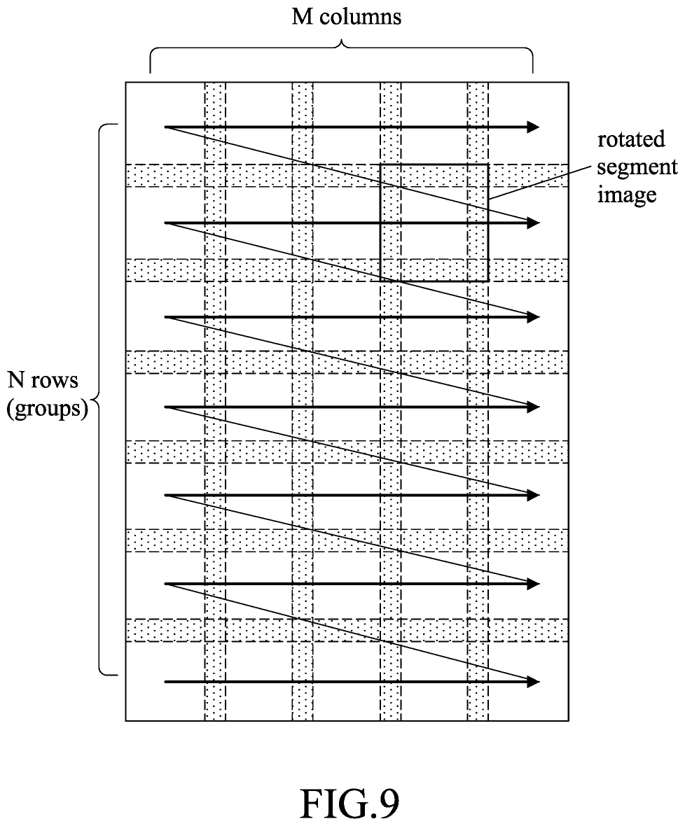

In order to fit the prescribed flow, the segment images that are captured column by column are rotated by 90 degrees, and the rotated segment images could be treated as if they were captured row by row, as illustrated in FIG. 9, where the segment images as shown in FIG. 8 are each rotated in a counterclockwise direction by 90 degrees, and thus form an N-by-M image array of the rotated segment images. As a result, step S61 can be performed on the rotated segment images to obtain stitch images that respectively correspond to first (bottom) to N^{th} (top) rows of the rotated segment images in FIG. 9.

In some cases where the prescribed flow is designed to combine the stitch images in the specific sequence of from top to bottom, the computer device 3 may number the stitch images for the first to N^{th} rows of the rotated segment images in FIG. 9 in a reverse order, and then perform steps 62 and 63 on the stitch images from the new first row (original N^{th} row) to the new N^{th} row (original first row) to form a rotated full image of the target scene 100. Subsequently, the computer device 3 rotates the rotated full image of the target scene 100 by 90 degrees in a clockwise direction, so as to obtain the full image of the target scene 100.

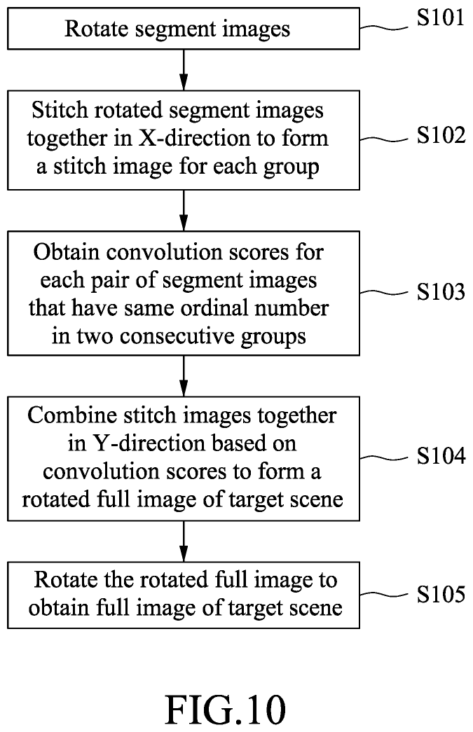

FIG. 10 illustrates a flow of the steps as illustrated above, exemplarily applied to the case depicted in FIG. 8.

In step S101, for each of the first to N^{th} groups (corresponding to first to N^{th} columns in FIG. 8), for each of the first to M^{th} images, once the image is captured, the computer device 3 rotates the image by 90 degrees in a rotational direction (e.g., the counterclockwise direction), so as to obtain rotated first to M^{th} images for the group.

In step S102, for each of the first to N^{th} groups and for each value of m, once the rotated m^{th} image and the rotated (m+1)^{th} image are obtained, steps S31 to S33 are performed on the rotated m^{th} image and the rotated (m+1)^{th} image that serve as the two adjacent segment images (i.e., this operation is performed (M−1) times, each with the variable m being a corresponding integer (from 1 to M−1)), so as to stitch the rotated first to M^{th} images together in the X-direction to form a stitch image for the corresponding group of the segment images (i.e., the corresponding row of the rotated segment images in FIG. 9).

In step S103, the computer device 3 performs, for a specific value of j (e.g., j=1) and for each value of n, the computer device 3 performs steps S31 and S32 on the rotated j^{th} image of the n^{th} group and the rotated j^{th} image of the (n+1)^{th} group (noting that the rotated j^{th} images of the n^{th} group and the (n+1)^{th} group are two adjacent segment images in the same column in FIG. 9) that serve as the two adjacent segment images in steps S31 to S33, so as to obtain a plurality of convolution scores (which can be used to determine a stitching position) for the rotated j^{th} images of the n^{th} group and the (n+1)^{th} group.

In step S104, for the specific value of j and for each value of n, the computer device 3 stitches the stitch image of the n^{th} group (corresponding to the n^{th} row in FIG. 9) and the stitch image of the (n+1)^{th} group (corresponding to the (n+1)^{th} row in FIG. 9) together in the Y-direction based on the stitching position obtained for the rotated j^{th} images of the n^{th} group and the (n+1)^{th} group, so as to obtain a rotated full image of the target scene 100.

In step S105, the computer device 3 rotates the rotated full image in another rotational direction (e.g., the clockwise direction) by 90 degrees, so as to obtain a full image of the target scene 100.

In some cases, steps S101-S105 may be performed after all of the segment images are captured when real time operation is not required.

According to the flow in FIG. 10, after rotating the segment images, steps S102-S104 can be performed on the rotated segment images in the manner as describe in steps S61-S63 in FIG. 6, and no complicated modification is required for the prescribed flow of FIG. 6 to stitch the segment images that are captured in a manner as shown in FIG. 8.

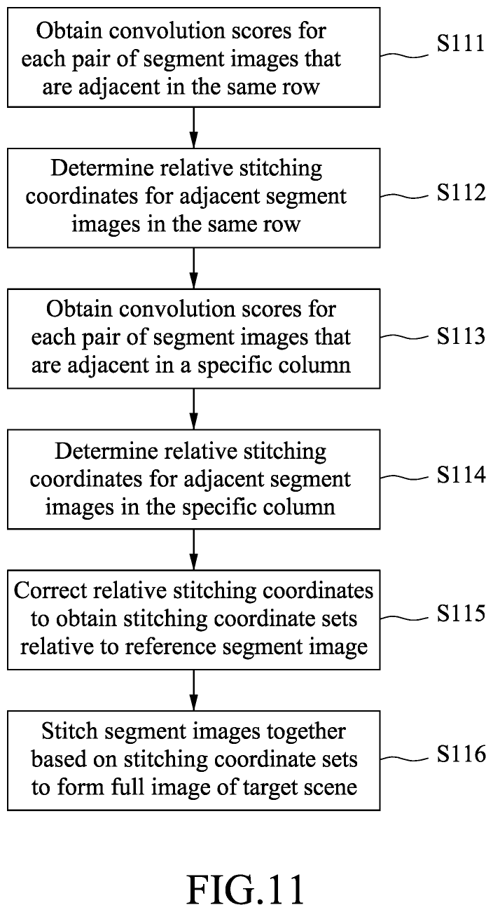

Referring to FIG. 11, a second embodiment of the image stitching method according to this disclosure is shown to be suitable for a scenario where the camera device 1 captures the segment images of a line (e.g., row or column) at predetermined, equidistant positions. In one example, the movement of the camera device 1 and the timing the camera device 1 captures the segment images may be precisely controlled to achieve equidistant image capturing even if the camera device 1 uses continuous shooting to capture the segment images while moving. In one example, each of the segment images may be captured after the camera device 1 moves to and stops at a corresponding one of predetermined positions that are arranged according to the route as shown in FIG. 2 or 8, rather than using continuous shooting to capture the segment images of a line while moving. Hereinafter, the route as shown in FIG. 2 is used as an example for ease of explanation, but this disclosure is not limited in this respect. Therefore, for each of the first to M^{th} groups (corresponding to first to M^{th} rows in FIG. 2) of the segment images, for different values of n, the common parts of the overlapping fields of view of the n^{th} image and the (n+1)^{th} image substantially have the same size.

In step S111, for each of the first to M^{th} groups and for each value of n, once the n^{th} image and the (n+1)^{th} image are captured, the computer device 3 performs steps S31 and S32 on the n^{th} image and the (n+1)^{th} image (i.e., two adjacent segment images in the same row in FIG. 2) that serve as the two adjacent segment images, so as to obtain a plurality of convolution scores for the n^{th} image and the (n+1)^{th} image of the corresponding group.

In step S112, for each of the first to M^{th} groups and for each value of n, the computer device 3 determines relative stitching coordinates (relative stitching position) for the n^{th} image and the (n+1)^{th} image based on the convolution scores obtained for n^{th} image and the (n+1)^{th} image.

In step S113, for a specific value of i (e.g., i=1) and for each value of m, the computer device 3 performs steps S31 and S32 on the i^{th} images of the m^{th} group and the (m+1)^{th} group of the segment images (i.e., two adjacent segment images of the same column in FIG. 2) that serve as the two adjacent segment images, so as to obtain a plurality of convolution scores (which can be used to determine a stitching position) for the i^{th} images of the m^{th} group and the (m+1)^{th} group of the segment images.

In step S114, for the specific value of i and for each value of m, the computer device 3 determines relative stitching coordinates (a relative stitching position) for the i^{th} images of the m^{th} group and the (m+1)^{th} group of the segment images based on the convolution scores obtained for the i^{th} images of the m^{th} group and the (m+1)^{th} group of the segment images.

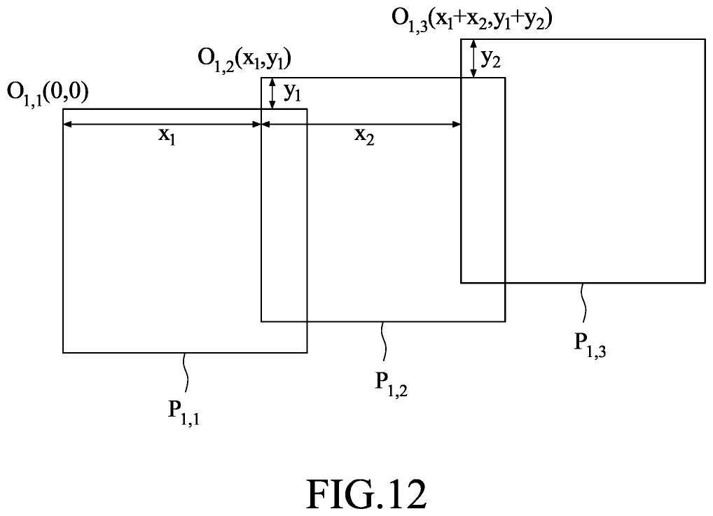

In step S115, the computer device 3 corrects the relative stitching coordinates obtained for the segment images based on a reference segment image, so as to obtain, for each of the segment images, a stitching coordinate set relative to the reference segment image, where the stitching coordinate set serves as an absolute stitching position. The stitching coordinate sets (absolute stitching positions) obtained in step S115 include those corrected from the relative stitching coordinates, and a stitching coordinate set that is predefined for the reference segment image. The reference segment image is one of the i^{th} images of the first to M^{th} groups of the segment images. Referring to FIG. 12, it is assumed that the computer device 3 determines that the segment image P_{1, 2} is to be stitched with the segment image P_{1, 1} by putting an upper left corner O_{1, 2} of the segment image P_{1, 2} at relative stitching coordinates (x₁, y₁) with respect to an upper left corner O_{1, 1} of the segment image P_{1, 1}, and that the segment image P_{1, 3} is to be stitched with the segment image P_{1, 2} by putting an upper left corner O_{1, 3} of the segment image P_{1, 3} at relative stitching coordinates (x₂, y₂) with respect to the upper left corner O_{1, 2} of the segment image P_{1, 2}. In step S115, the computer device 3 may use the segment image P_{1, 1} as the reference segment image (i.e., i=1), and correct the relative stitching coordinates (x₂, y₂) for the segment image P_{1, 3} relative to the segment image P_{1, 2} to obtain a stitching coordinate set of (x₁+x₂, y₁+y₂) relative to the upper left corner O_{1, 1} of the segment image P_{1, 1}. In a similar manner, the relative stitching coordinates determined in step S112 for the segment images of each group and the relative stitching coordinates determined in step S114 for the i^{th} images of the first to M^{th} groups can be corrected to respective stitching coordinate sets relative to the reference segment image in step S115.

In step S116, for each of the first to M^{th} groups of the segment images and for each value of n, the computer device 3 performs step S33 on the n^{th} image and the (n+1)^{th} image (i.e., two adjacent segment images in the same row in FIG. 2) that serve as the two adjacent segment images based on the stitching coordinate sets of the n^{th} image and the (n+1)^{th} image, and, for each value of i and for each value of m, the computer device 3 performs step S33 on the i^{th} images of the m^{th} group and the (m+1)^{th} group of the segment images (i.e., two adjacent segment images in the same column) that serve as the two adjacent segment images based on the stitching coordinate sets of the i^{th} images of the m^{th} group and the (m+1)^{th} group of the segment images, so as to stitch all the segment images together to form a full image of the target scene 100. In other words, all of the segment images are stitched together in step S116 by simply putting the segment images at positions indicated by the stitching coordinate sets in a single operation.

In some cases, steps S111-S116 may be performed after all of the segment images are captured when real time operation is not required.

In the case where the camera device 1 captures the segment images along the route as shown in FIG. 8, the second embodiment is also applicable by interchanging “X-direction” and “Y-direction”, or by rotating the segment images as described with reference to the first embodiment, as can be easily understood by one skilled in the art, so details thereof are omitted herein for the sake of brevity.

It is noted that, in the second embodiment, generation of the stitch images (see step S61 in FIG. 6 and step S102 in FIG. 10) is not necessary, so memory capacity of the computer device 3 can be saved in comparison to the first embodiment.

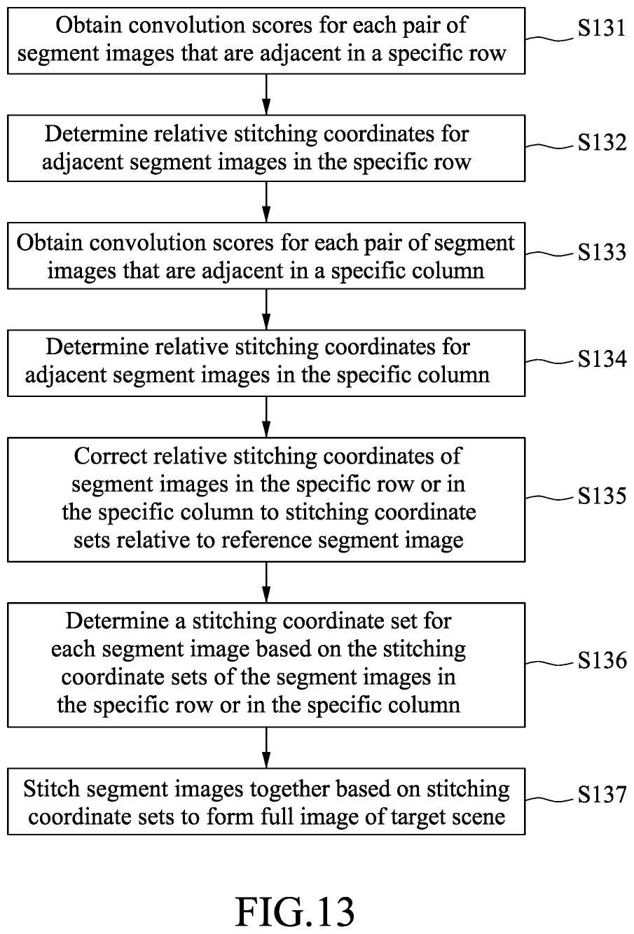

Referring to FIG. 13, a variation of the second embodiment of the image stitching method according to this disclosure is shown to be suitable for the scenario where the segment images in the same line (row or column) are captured at predetermined, equidistant positions. Hereinafter, the route as shown in FIG. 2 is used as an example for ease of explanation, but this disclosure is not limited in this respect. Therefore, for each of the first to M^{th} groups (corresponding to the first to M^{th} rows in FIG. 2) of the segment images and for different values of n, the common parts of the overlapping fields of view of the n^{th} image and the (n+1)^{th} images substantially have the same size.

In step S131, for a specific one of the first to M^{th} groups and for each value of n, once the n^{th} image and the (n+1)^{th} image are captured, the computer device 3 performs steps S31 and S32 on the n^{th} image and the (n+1)^{th} image that serve as the two adjacent segment images, so as to obtain a plurality of convolution scores for the n^{th} image and the (n+1)^{th} image of the specific one of the first to M^{th} groups.

In step S132, for the specific one of the first to M^{th} groups and for each value of n, the computer device 3 determines relative stitching coordinates (a relative stitching position) for the n^{th} image and the (n+1)^{th} image based on the convolution scores obtained for the n^{th} image and the (n+1)^{th} image. As an example, the computer device 3 may determine the relative stitching coordinates for each pair of adjacent segment images of the first row in steps S131 and S132 (i.e., the specific one of the first to M^{th} groups is the first group, which corresponds to the first row in FIG. 2).

In step S133, for a specific value of i and for each value of m, the computer device 3 performs steps S31 and S32 on the i^{th} images of the m^{th} group and the (m+1)^{th} group of the segment images that serve as the two adjacent segment images, so as to obtain a plurality of convolution scores for the i^{th} images of the m^{th} group and the (m+1)^{th} group of the segment images.

In step S134, for the specific value of i and for each value of m, the computer device 3 determines relative stitching coordinates for the i^{th} images of the m^{th} group and the (m+1)^{th} group of the segment images based on the convolution scores obtained for the i^{th} images of the m^{th} group and the (m+1)^{th} group of the segment images. As an example, the computer device 3 may determine the relative stitching coordinates for each pair of adjacent segment images of the first column (i.e., i=1) in FIG. 2 in steps S133 and S134.

In step S135, for the specific value of i, based on a reference segment image that is the i^{th} image of the specific one of the first to M^{th} groups, the computer device 3 corrects the relative stitching coordinates obtained for the first to N^{th} images of the specific one of the first to M^{th} groups, and the relative stitching coordinates obtained for the i^{th} images of the first to M^{th} groups of the segment images, so as to obtain, for each of the first to N^{th} images of the specific one of the first to M^{th} groups and the i^{th} images of the first to M^{th} groups of the segment images, a stitching coordinate set (absolute stitching position) relative to the reference segment image. Taking FIG. 2 as an example, the computer device 3 calculates a stitching coordinate set relative to the segment image of the first row and the first column (the reference segment image) for each of the segment images in the first row and the first column.

In step S136, for the specific value of i (a specific positive integer selected from one to N), for each value of a variable k, which takes a positive integer value ranging from one to N except for said specific value of i, and for each value of j (recall that j is a variable that takes a positive integer value ranging from one to M), the computer device 3 determines a stitching coordinate set relative to the reference segment image for a k^{th} image of the j^{th} group of the segment images based on the k^{th} image of the specific one of the first to M^{th} groups and the i^{th} image of the j^{th} row of the segment images, where the j^{th} row is different from the specific one of the first to M^{th} rows. As an example, assuming that the reference segment image is the first image (the specific value of i is 1) of the first group (corresponding to the first row in FIG. 2), that the third image of the first group has a stitching coordinate set of (x₃, y₁) that is determined in step S135, and that the first image of the fourth group (corresponding to the fourth row in FIG. 2) has a stitching coordinate set of (x₁, y₄) that is determined in step S135, the computer device 3 may determine, for the third image of the fourth group, a stitching coordinate set relative to the reference segment image to be (x₁+x₃, y₁+y₄).

In step S137, for each of the first to M^{th} groups of the segment images and for each value of n, the computer device 3 performs step S33 on the n^{th} image and the (n+1)^{th} image that serve as the two adjacent segment images based on the stitching coordinate sets of the n^{th} image and the (n+1)^{th} image, and for each value of i and for each value of m, the computer device 3 performs step S33 on the i^{th} images of the m^{th} group and the (m+1)^{th} group of the segment images that serve as the two adjacent segment images based on the stitching coordinate sets of the i^{th} images of the m^{th} group and the (m+1)^{th} group of the segment images, so as to stitch the segment images together to form a full image of the target scene 100.

In this variation, convolution is performed on only one row and one column (from the perspective of the target scene 100) of the segment images, and the stitching coordinate sets of the other segment images can be acquired using simple elementary arithmetic (e.g., addition and subtraction), so the computation load is reduced.

In summary, an image stitching method is proposed to include several embodiments. In the first embodiment, the segment images in the same line (row or column) are stitched together to form multiple stitch images of the lines, and the stitch images are stitched together to form the full image. As an example, convolution is performed to determine a stitching position for two adjacent images. In the second embodiment, the stitching coordinate sets of the segment images are calculated, and the segment images are stitched together based on the stitching coordinate sets at the end, so as to save memory capacity. In a variation of the second embodiment, the stitching coordinate sets are calculated only for the segment image of one row and one column, so as to reduce computation load. Furthermore, with the option of allowing the user to define the convolution region, in the segment image where the convolution region is to be defined, some parts of the segment image that the user deems impossible to include the stitching position can be excluded from the convolution region by the user, thereby reducing chances of misjudging the stitching position, so the embodiments of this disclosure are suitable for a target scene that has duplicated features.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An image stitching method, comprising steps of:
A) acquiring a plurality of segment images for a target scene, each of the segment images containing a part of a target scene;
B) for two adjacent segment images, which are two of the segment images that have overlapping fields of view, comparing the two adjacent segment images to determine a stitching position for the two adjacent segment images from a common part of the overlapping fields of view; and
C) stitching the two adjacent images together based on the stitching position thus determined.

2. The image stitching method of claim 1, wherein the segment images are captured line by line in sequence along a first direction and are classified into first to M^{th} groups according to an order in which the segment images are captured, where M is a positive integer greater than one;
wherein each of the first to M^{th} groups includes N number of the segment images, which are referred to as first to N^{th} images and which are captured one by one in sequence along a second direction transverse to the first direction, where N is a positive integer greater than one;
wherein, for each of the first to M^{th} groups, an n^{th} image and an (n+1)^{th} image have overlapping fields of view, where n is a variable that takes a positive integer value ranging from one to (N−1); and
wherein an i^{th} image of an m^{th} group of the segment images and an i^{th} image of an (m+1)^{th} group of the segment images have overlapping fields of view, where m is a variable that takes a positive integer value ranging from one to (M−1), and i is a variable that takes a positive integer value ranging from one to N;
said image stitching method further comprising a step of D) for each of the first to M^{th} groups and for each value of n, after the n^{th} image and the (n+1)^{th} image are captured, performing steps B) and C) on the n^{th} image and the (n+1)^{th} image that serve as the two adjacent segment images, so as to stitch the first to N^{th} images together in the second direction to form a stitch image for said each of the first to M^{th} groups.

3. The image stitching method of claim 2, further comprising steps of:
E) for a specific value of i and for each value of m, performing step B) on the i^{th} images of the m^{th} group and the (m+1)^{th} group of the segment images that serve the two adjacent segment images, so as to obtain the stitching position for the i^{th} images of the m^{th} group and the (m+1)^{th} group of the segment images; and
F) for the specific value of i and each value of m, stitching the stitch images of the m^{th} group and the (m+1)^{th} group together in the first direction based on the stitching position obtained for the i^{th} images of the m^{th} group and the (m+1)^{th} group of the segment images, so as to obtain a full image of the target scene.

4. The image stitching method of claim 1, wherein the segment images are classified into first to N^{th} groups, where N is a positive integer greater than one;
wherein each of the first to N^{th} groups includes M number of the segment images, which are referred to as first to M^{th} images and which are captured one by one in sequence along a first direction, where M is a positive integer greater than one;
wherein the first to N^{th} groups are captured line by line in sequence along a second direction transverse to the first direction, and the segment images are classified into the first to N^{th} groups according to an order in which the segment images are captured;
wherein, for each of the first to N^{th} groups, an m^{th} image and an (m+1)^{th} image have overlapping fields of view, where m is a variable that takes a positive integer value ranging from one to (M−1); and
wherein a j^{th} image of an n^{th} group of the segment images and a j^{th} image of an (n+1)^{th} group of the segment images have overlapping fields of view, where n is a variable that takes a positive integer value ranging from one to (N−1), and j is a variable that takes a positive integer value ranging from one to M;
said image stitching method further comprising steps of:
D) for each of the first to N^{th} groups, after each of the first to M^{th} images is captured, rotating said each of the first to M^{th} images by 90 degrees in a rotational direction, so as to obtain rotated first to M^{th} images;
E) for each of the first to N^{th} groups and for each value of m, after the rotated m^{th} image and the rotated (m+1)^{th} image are obtained, performing steps B) and C) on the rotated m^{th} image and the rotated (m+1)^{th} image that serve as the two adjacent segment images, so as to stitch the rotated first to M^{th} images together in the second direction to form a stitch image for said each of the first to N^{th} groups.

5. The image stitching method of claim 4, further comprising steps of:
F) for a specific value of j and for each value of n, performing step B) on the j^{th} images of the n^{th} group and the (n+1)^{th} group of the segment images that serve the two adjacent segment images, so as to obtain the stitching position for the j^{th} images of the n^{th} group and the (n+1)^{th} group of the segment images; and
G) for the specific value of j and for each value of n, stitching the stitch images of the n^{th} group and the (n+1)^{th} group together in the first direction based on the stitching position obtained for the j^{th} images of the n^{th} group and the (n+1)^{th} group of the segment images, so as to obtain a full image of the target scene.

6. The image stitching method of claim 1, wherein the segment images are captured line by line in sequence along a first direction, and are classified into first to M^{th} groups according to an order in which the segment images are captured, where M is a positive integer greater than one;
wherein each of the first to M^{th} groups includes N number of the segment images, which are referred to as first to N^{th} images and which are captured one by one in sequence along a second direction transverse to the first direction, where N is a positive integer greater than one;
wherein, for each of the first to M^{th} groups, an n^{th} image and an (n+1)^{th} image have overlapping fields of view, where n is a variable that takes a positive integer value ranging from one to (N−1);
wherein an i^{th} image of an m^{th} group of the segment images and an i^{th} image of an (m+1)^{th} group of the segment images have overlapping fields of view, where m is a variable that takes a positive integer value ranging from one to (M−1), and i is a variable that takes a positive integer value ranging from one to N; and
wherein, for each of the first to M^{th} groups of the segment images, the common parts of the overlapping fields of view of the n^{th} image and the (n+1)^{th} image for different values of n have a same size;
said image stitching method further comprising a step of:
D) for each of the first to M^{th} groups and for each value of n, after the n^{th} image and the (n+1)^{th} image are captured, performing step B) on the n^{th} image and the (n+1)^{th} image that serve as the two adjacent segment images, so as to obtain a relative stitching position for the n^{th} image and the (n+1)^{th} image;
E) for a specific value of i and for each value of m, performing step B) on the i^{th} images of the m^{th} group and the (m+1)^{th} group of the segment images that serve as the two adjacent segment images, so as to obtain a relative stitching position for the i^{th} images of the m^{th} group and the (m+1)^{th} group;
F) for the specific value of i, correcting the relative stitching positions obtained for the segment images based on a reference segment image that is one of the i^{th} images of the first to M^{th} groups of the segment images, so as to obtain, for each of the segment images, an absolute stitching position relative to the reference segment image;
G) for each of the first to M^{th} groups of the segment images and for each value of n, performing step C) on the n^{th} image and the (n+1)^{th} image that serve as the two adjacent segment images based on the absolute stitching positions of the n^{th} image and the (n+1)^{th} image, and, for each value of i and for each value of m, performing step C) on the i^{th} images of the m^{th} group and the (m+1)^{th} group of the segment images that serve as the two adjacent segment images based on the absolute stitching positions of the i^{th} images of the m^{th} group and the (m+1)^{th} group of the segment images, so as to stitch the segment images together to form a full image of the target scene.

7. The image stitching method of claim 1, wherein the segment images are captured line by line in sequence along a first direction and are classified into first to M^{th} lines according to an order in which the segment images are captured, where M is a positive integer greater than one;
wherein each of the first to M^{th} groups includes N number of the segment images, which are referred to as first to N^{th} images and which are captured one by one in sequence along a second direction transverse to the first direction, where N is a positive integer greater than one;
wherein, for each of the first to M^{th} groups, an n^{th} image and an (n+1)^{th} image have overlapping fields of view, where n is a variable that takes a positive integer value ranging from one to (N−1);
wherein an i^{th} image of an m^{th} group of the segment images and an i^{th} image of an (m+1)^{th} group of the segment images have overlapping fields of view, where m is a variable that takes a positive integer value ranging from one to (M−1), and i is a variable that takes a positive integer value ranging from one to N; and
wherein, for each of the first to M^{th} groups of the segment images, the common parts of the overlapping fields of view of the n^{th} image and the (n+1)^{th} image for different values of n have a same size;
said image stitching method further comprising a step of:
D) for a specific one of the first to M^{th} groups and for each value of n, after the n^{th} image and the (n+1)^{th} image are captured, performing step B) on the n^{th} image and the (n+1)^{th} image that serve as the two adjacent segment images, so as to obtain a relative stitching position for the n^{th} image and the (n+1)^{th} image;
E) for a specific value of i and for each value of m, performing step B) on the i^{th} images of the m^{th} group and the (m+1)^{th} group of the segment images that serve as the two adjacent segment images, so as to obtain a relative stitching position for the i^{th} images of the m^{th} group and the (m+1)^{th} group;
F) for the specific value of i, correcting, based on a reference segment image that is the i^{th} image of the specific one of the first to M^{th} groups, the relative stitching positions obtained for the first to N^{th} images of the specific one of the first to M^{th} groups, and the relative stitching positions obtained for the i^{th} images of the first to M^{th} groups of the segment images, so as to obtain, for each of the first to N^{th} images of the specific one of the first to M^{th} groups and the i^{th} images of the first to M^{th} groups of the segment images, an absolute stitching position relative to the reference segment image;
G) determining, for the specific value of i, for each value of a variable k, which takes a positive integer value ranging from one to N except for said specific value of i, and for each value of j, which is a variable that takes a positive integer value ranging from one to M, an absolute stitching position relative to the reference segment image for a k^{th} image of a j^{th} group of the segment images based on the k^{th} image of the specific one of the first to M^{th} groups and the i^{th} image of the j^{th} group of the segment images, where the j^{th} group is different from the specific one of the first to M^{th} groups; and
H) for each of the first to M^{th} groups of the segment images and for each value of n, performing step C) on the n^{th} image and the (n+1)^{th} image that serve as the two adjacent segment images based on the absolute stitching positions of the n^{th} image and the (n+1)^{th} image, and, for each value of i and for each value of m, performing step C) on the i^{th} images of the m^{th} group and the (m+1)^{th} group of the segment images that serve as the two adjacent segment images based on the absolute stitching positions of the i^{th} images of the m^{th} group and the (m+1)^{th} group of the segment images, so as to stitch the segment images together to form a full image of the target scene.

8. The image stitching method of claim 1, wherein step B) includes sub-steps of:
B-1) obtaining a convolution kernel from one of the two adjacent segment images, and defining a convolution region in the other one of the two adjacent segment images, wherein the convolution kernel includes, at least in part, data of the common part of the overlapping fields of view, and the convolution region includes, at least in part, data of the common part of the overlapping fields of view; and
B-2) using the convolution kernel to perform convolution on the convolution region to obtain a plurality of convolution scores for different sections of the convolution region; and
step C) includes stitching the two adjacent segment images together based on the convolution scores.

9. The image stitching method of claim 8, wherein the segment images are captured line by line in sequence along a first direction, and are classified into first to M^{th} groups according to an order in which the segment images are captured, where M is a positive integer greater than one;
wherein each of the first to M^{th} groups includes N number of the segment images, which are referred to as first to N^{th} images and which are captured one by one in sequence along a second direction transverse to the first direction, where N is a positive integer greater than one;
wherein, for each of the first to M^{th} groups, an n^{th} image and an (n+1)^{th} image have overlapping fields of view, where n is a variable that takes a positive integer value ranging from one to (N−1); and
wherein an i^{th} image of an m^{th} group of the segment images and an i^{th} image of an (m+1)^{th} group of the segment images have overlapping fields of view, where m is a variable that takes a positive integer value ranging from one to (M−1), and i is a variable that takes a positive integer value ranging from one to N;
said image stitching method further comprising a step of D) for each of the first to M^{th} groups and for each value of n, after the n^{th} image and the (n+1)^{th} image are captured, performing steps B) and C) on the n^{th} image and the (n+1)^{th} image that serve as the two adjacent segment images, so as to stitch the first to N^{th} images together in the second direction to form a stitch image for said each of the first to M^{th} groups.

10. The image stitching method of claim 9, further comprising steps of:
E) for a specific value of i and for each value of m, performing sub-steps B-1) and B-2) on the i^{th} images of the m^{th} group and the (m+1)^{th} group of the segment images that serve as the two adjacent segment images, so as to obtain a plurality of convolution scores for the i^{th} images of the m^{th} group and the (m+1)^{th} group of the segment images; and
F) for the specific value of i and for each value of m, stitching the stitch images of the m^{th} group and the (m+1)^{th} group together in the first direction based on the convolution scores obtained for the i^{th} images of the m^{th} group and the (m+1)^{th} group of the segment images, so as to obtain a full image of the target scene.

11. The image stitching method of claim 9, wherein, for each of the first to M^{th} groups of the segment images, the common parts of the overlapping fields of view of the n^{th} image and the (n+1)^{th} images vary in size for different values of n; and
wherein, in step D), sub-steps B-1) and B-2) are repeatedly performed on the n^{th} image and the (n+1)^{th} image of said each of the first to M^{th} groups, and, for each of the repetitions of sub-steps B-1) and B-2), at least one of the convolution kernel or the convolution region is different in size from that of another repetition.

12. The image stitching method of claim 9, wherein step D) further includes, before step C), normalizing the convolution scores obtained in each of the repetitions of sub-steps B-1) and B-2) based on a size of the convolution kernel used in the repetition; and
wherein the stitching in step C) is performed based on the convolution scores thus normalized for all of the repetitions of sub-steps B-1) and B-2).

13. The image stitching method of claim 8, wherein the segment images are classified into first to N^{th} groups, where N is a positive integer greater than one;
wherein each of the first to N^{th} groups includes M number of the segment images, which are referred to as first to M^{th} images and which are captured one by one in sequence along a first direction, where M is a positive integer greater than one;
wherein the segment images are captured line by line in sequence along a second direction transverse to the first direction, and are classified into the first to N^{th} groups according to an order in which the segment images are captured;
wherein, for each of the first to N^{th} groups, an m^{th} image and an (m+1)^{th} image have overlapping fields of view, where m is a variable that takes a positive integer value ranging from one to (M−1); and
wherein a j^{th} image of an n^{th} group of the segment images and a j^{th} image of an (n+1)^{th} group of the segment images have overlapping fields of view, where n is a variable that takes a positive integer value ranging from one to (N−1), and j is a variable that takes a positive integer value ranging from one to M;
said image stitching method further comprising steps of:
D) for each of the first to N^{th} groups, after each of the first to M^{th} images is captured, rotating said each of the first to M^{th} images by 90 degrees in a rotational direction, so as to obtain rotated first to M^{th} images;
E) for each of the first to N^{th} groups and for each value of m, after the rotated m^{th} image and the rotated (m+1)^{th} image are obtained, performing steps B) and C) on the rotated m^{th} image and the rotated (m+1)^{th} image that serve as the two adjacent segment images, so as to stitch the rotated first to M^{th} images together in the second direction to form a stitch image for said each of the first to N^{th} groups.

14. The image stitching method of claim 13, further comprising steps of:
F) for a specific value of j and for each value of n, performing sub-steps B-1) and B-2) on the j^{th} images of the n^{th} group and the (n+1)^{th} group of the segment images that serve as the two adjacent segment images, so as to obtain a plurality of convolution scores for the j^{th} images of the n^{th} group and the (n+1)^{th} group of the segment images; and
G) for the specific value of j and for each value of n, stitching the stitch images of the n^{th} group and the (n+1)^{th} group together in the first direction based on the convolution scores obtained for the j^{th} images of the n^{th} group and the (n+1)^{th} group of the segment images, so as to obtain a full image of the target scene.

15. The image stitching method of claim 8, wherein the segment images are captured line by line in sequence along a first direction, and are classified into first to M^{th} groups according to an order in which the segment images are captured, where M is a positive integer greater than one;
wherein each of the first to M^{th} groups includes N number of the segment images, which are referred to as first to N^{th} images and which are captured one by one in sequence along a second direction transverse to the first direction, where N is a positive integer greater than one;
wherein, for each of the first to M^{th} groups, an n^{th} image and an (n+1)^{th} image have overlapping fields of view, where n is a variable that takes a positive integer value ranging from one to (N−1);
wherein an i^{th} image of an m^{th} group of the segment images and an i^{th} image of an (m+1)^{th} group of the segment images have overlapping fields of view, where m is a variable that takes a positive integer value ranging from one to (M−1), and i is a variable that takes a positive integer value ranging from one to N; and
wherein, for each of the first to M^{th} groups of the segment images, the common parts of the overlapping fields of view of the n^{th} image and the (n+1)^{th} image for different values of n have a same size;
said image stitching method further comprising a step of:
D) for each of the first to M^{th} groups and for each value of n, after the n^{th} image and the (n+1)^{th} image are captured, performing sub-steps B-1) and B-2) on the n^{th} image and the (n+1)^{th} image that serve as the two adjacent segment images, so as to obtain a plurality of convolution scores for the n^{th} image and the (n+1)^{th} image of said each of the first to M^{th} groups;
E) for each of the first to M^{th} groups and for each value of n, determining relative stitching coordinates for the n^{th} image and the (n+1)^{th} image based on the convolution scores obtained for n^{th} image and the (n+1)^{th} image;
F) for a specific value of i and for each value of m, performing sub-steps B-1) and B-2) on the i^{th} images of the m^{th} group and the (m+1)^{th} group of the segment images that serve as the two adjacent segment images, so as to obtain a plurality of convolution scores for the i^{th} images of the m^{th} group and the (m+1)^{th} group of the segment images;
G) for the specific value of i and for each value of m, determining relative stitching coordinates for the i^{th} images of the m^{th} group and the (m+1)^{th} group of the segment images based on the convolution scores obtained for the i^{th} images of the m^{th} group and the (m+1)^{th} group of the segment images;
H) for the specific value of i, correcting the relative stitching coordinates obtained for the segment images based on a reference segment image that is one of the i^{th} images of the first to M^{th} lines of the segment images, so as to obtain, for each of the segment images, a stitching coordinate set relative to the reference segment image; and
I) for each of the first to M^{th} groups of the segment images and for each value of n, performing step C) on the n^{th} image and the (n+1)^{th} image that serve as the two adjacent segment images based on the stitching coordinate sets of the n^{th} image and the (n+1)^{th} image, and, for each value of i and for each value of m, performing step C) on the i^{th} images of the m^{th} group and the (m+1)^{th} group of the segment images that serve as the two adjacent segment images based on the stitching coordinate sets of the i^{th} images of the m^{th} group and the (m+1)^{th} group of the segment images, so as to stitch the segment images together to form the full image of a target scene.

16. The image stitching method of claim 8, wherein the segment images are captured line by line in sequence along a first direction, and are classified into first to M^{th} groups according to an order in which the segment images are captured, where M is a positive integer greater than one;
wherein each of the first to M^{th} groups includes N number of the segment images, which are referred to as first to N^{th} images and which are captured one by one in sequence along a second direction transverse to the first direction, where N is a positive integer greater than one;
wherein, for each of the first to M^{th} groups, an n^{th} image and an (n+1)^{th} image have overlapping fields of view, where n is a variable that takes a positive integer value ranging from one to (N−1);
wherein an i^{th} image of an m^{th} group of the segment images and an i^{th} image of an (m+1)^{th} group of the segment images have overlapping fields of view, where m is a variable that takes a positive integer value ranging from one to (M−1), and i is a variable that takes a positive integer value ranging from one to N; and
wherein, for each of the first to M^{th} groups of the segment images, the common parts of the overlapping fields of view of the n^{th} image and the (n+1)^{th} image for different values of n have a same size;
said image stitching method further comprising a step of:
D) for a specific one of the first to M^{th} groups and for each value of n, after the n^{th} image and the (n+1)^{th} image are captured, performing sub-steps B-1) to B-2) on the n^{th} image and the (n+1)^{th} image that serve as the two adjacent segment images, so as to obtain a plurality of convolution scores for the n^{th} image and the (n+1)^{th} image of the specific one of the first to M^{th} groups;
E) for the specific one of the first to M^{th} groups and for each value of n, determining relative stitching coordinates for the n^{th} image and the (n+1)^{th} image based on the convolution scores obtained for n^{th} image and the (n+1)^{th} image;
F) for a specific value of i and for each value of m, performing sub-steps B-1) and B-2) on the i^{th} images of the m^{th} group and the (m+1)^{th} group of the segment images that serve as the two adjacent segment images, so as to obtain a plurality of convolution scores for the i^{th} images of the m^{th} group and the (m+1)^{th} group of the segment images;
G) for the specific value of i and for each value of m, determining relative stitching coordinates for the i^{th} images of the m^{th} group and the (m+1)^{th} group of the segment images based on the convolution scores obtained for the i^{th} images of the m^{th} group and the (m+1)^{th} group of the segment images;
H) for the specific value of i, correcting, based on a reference segment image that is the i^{th} image of the specific one of the first to M^{th} groups, the relative stitching coordinates obtained for the first to N^{th} images of the specific one of the first to M^{th} groups, and the relative stitching coordinates obtained for the i^{th} images of the first to M^{th} groups of the segment images, so as to obtain, for each of the first to N^{th} images of the specific one of the first to M^{th} groups and the i^{th} images of the first to M^{th} groups of the segment images, a stitching coordinate set relative to the reference segment image;
I) determining, for each value of a variable k, which takes a positive integer value ranging from one to N except for said specific value of i, and for each value of a variable j, which takes a positive integer value ranging from one to M, a stitching coordinate set relative to the reference segment image for a k^{th} image of a j^{th} group of the segment images based on the k^{th} image of the specific one of the first to M^{th} groups and the i^{th} image of the j^{th} group of the segment images, where the j^{th} group is different from the specific one of the first to M^{th} groups; and
J) for each of the first to M^{th} groups of the segment images and for each value of n, performing step C) on the n^{th} image and the (n+1)^{th} image that serve as the two adjacent segment images based on the stitching coordinate sets of the n^{th} image and the (n+1)^{th} image, and, for each value of i and for each value of m, performing step C) on the i^{th} images of the m^{th} group and the (m+1)^{th} group of the segment images that serve as the two adjacent segment images based on the stitching coordinate sets of the i^{th} images of the m^{th} group and the (m+1)^{th} group of the segment images, so as to stitch the segment images together to form a full image of the target scene.
